(19) United States
(12) Patent Application Publication
(10) Pub. No.: US 2008/0209048 A1
(43) Pub. Date: Aug. 28, 2008

(54) Loading A Mirror Driver In Remote Terminal Server Session

(75) Inventors: Sriram Sampath, Redmond, WA (US); Pravin Santiago, Bellevue, WA (US); Hao Chen, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/680,446

(22) Filed: Feb. 28, 2007

(51) Int. Cl. G06F 15/16

(52) U.S. Cl. 709/227

(57) ABSTRACT

Described are systems and methods for loading mirror drivers in remote sessions of a remote server that enables remote sessions at various computing or client devices to access the mirror drivers. The mirror drivers are video display drivers which receives video rendering output and/or graphics output from a graphics device interface. Such video rendering output and/or graphics output received may be a mirror image of the video rendering output and/or graphics output send to display drivers for displaying on monitor.

### BACKGROUND

Typically applications relying on mirror drivers run on locally attached sessions of a computing device in a network environment. The mirror drivers facilitate sharing of sessions of applications associated with a local computing device (i.e., a user or a client computing device) with other computing devices. These applications may include, application related to desktop screen sharing applications or scenarios (i.e., collaboration screen sharing applications, net meeting, desktop magnifier applications, etc.) Further, such execution of applications results in reflection of changes being made in one session of a computing device on other sessions of other computing devices. Therefore, there is a continuing need for improved techniques for executing applications associated with mirror drivers, especially in a network environment.

### SUMMARY

This summary is provided to introduce simplified concepts of loading a mirror driver in remote terminal server session, which is further described below in the Detailed Description. This summary is not intended to identify essential features of the claimed subject matter, nor is it intended for use in determining the scope of the claimed subject matter.

In an embodiment, a mirror driver is loaded at a remote terminal server, and applications relying on the mirror driver can run on remote terminal server sessions.

### BRIEF DESCRIPTION OF THE CONTENTS

The detailed description is described with reference to the accompanying figures. In the figures, the left-most digit(s) of a reference number identifies the figure in which the reference number first appears. The use of the same reference number in different figures indicates similar or identical items.

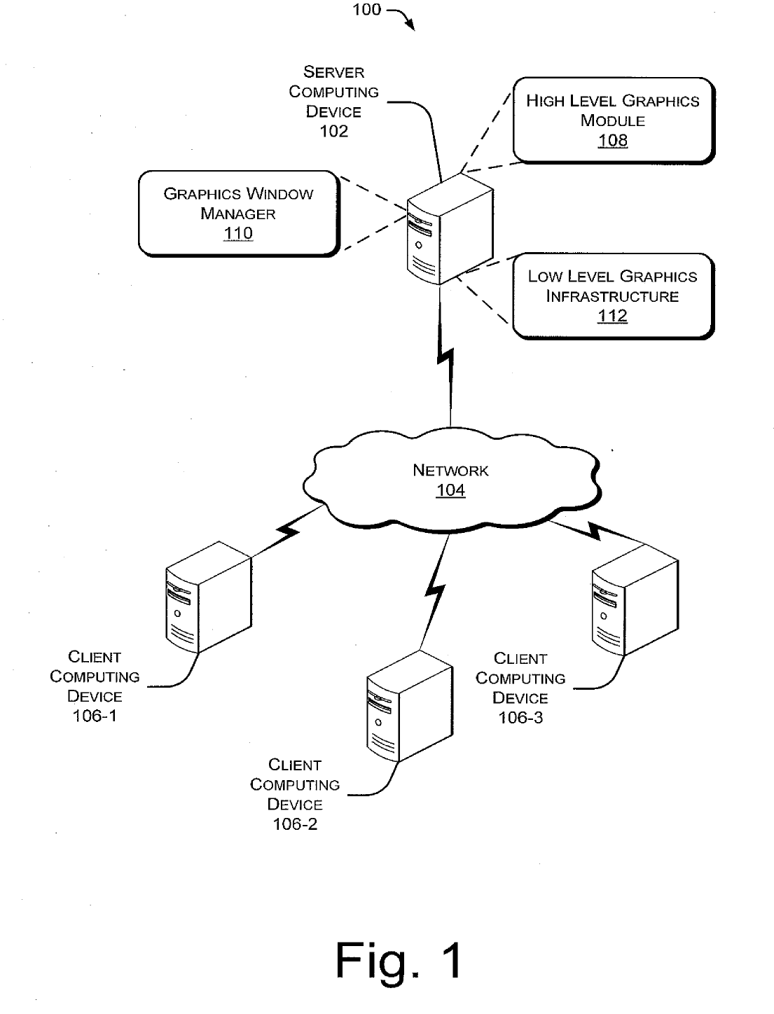

FIG. 1 is an illustration of an exemplary remote server access system loaded with a mirror driver in a client-server computing environment, according to one embodiment.

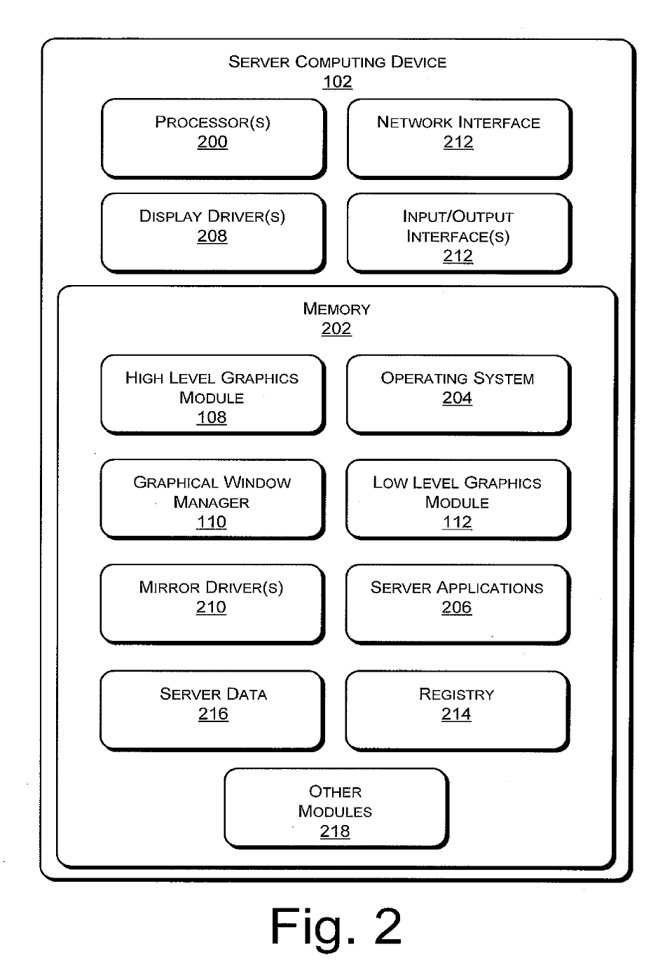

FIG. 2 is an illustration of an implementation of a server computing device capable of being loaded with mirror drivers in remote sessions.

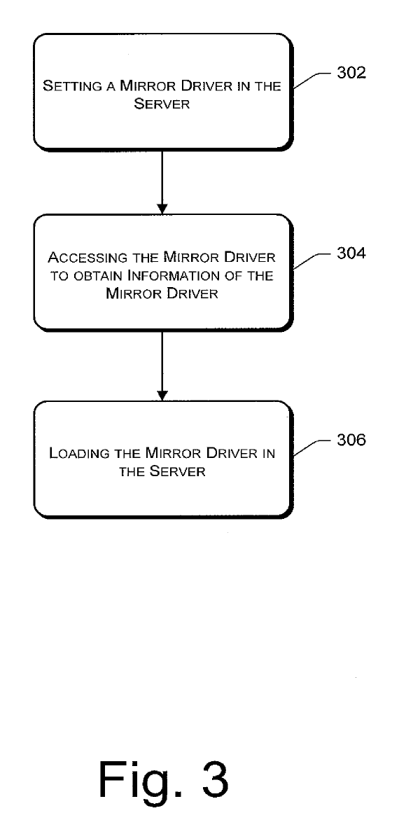

FIG. 3 is a flowchart that illustrates an exemplary method for loading a mirror driver in a server computing device.

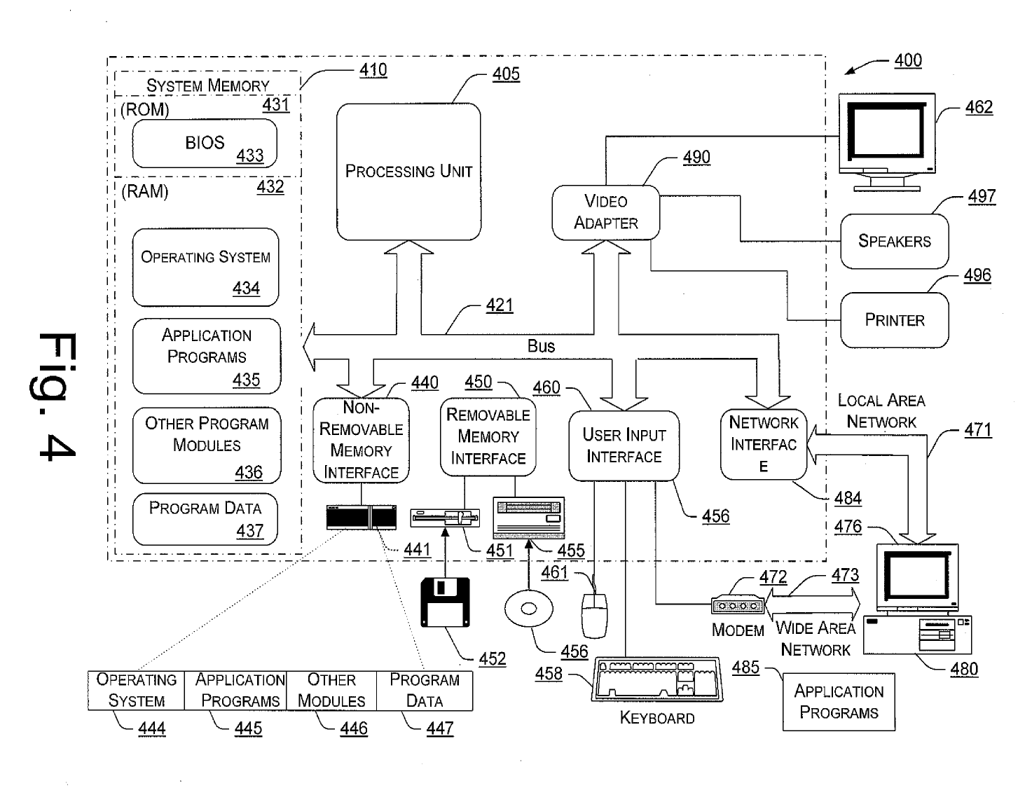

FIG. 4 is an illustration of an exemplary computing device.

### DETAILED DESCRIPTION

The following disclosure describes techniques for loading mirror drivers in remote server computing device (e.g., a terminal server) enabling the remote sessions (i.e., at various computing devices) to access the mirror drivers. The mirror drivers are video display drivers which receives video rendering output and/or graphics output from a graphics device interface (GDI). Such video rendering output and/or graphics output received may be a mirror image of the video rendering output and/or graphics output send to display drivers for displaying on monitor. For example, in case of collaborative applications or scenarios such as net meeting, usage of mirror drivers enables one or more person to view the net meeting in a single screen simultaneously. Once, the mirror drivers are connected to the remote server computing device, capabilities of the server sessions may be replicated in the remote sessions (i.e., at various computing devices).

The following disclosure describes systems and methods for loading mirror drivers to remote server computing devices. While aspects of described systems and methods for loading mirror drivers can be implemented in any number of different computing systems, environments, and/or configurations, embodiments of the systems and methods are described in the context of the following exemplary system architecture(s).

### Sessionization of Device Nodes

In a Windows® operating system graphics subsystem, a data structure called “device node” may used to capture key properties of a display driver(s) which device node is loading. In other words, device node may be an internal data structure used by Windows® operating system graphics subsystem to capture properties of a display device. Such information may be found (i.e., stored in) a Windows® database known as the system registry. The Windows® system registry is common for the entire system; however, the registry may not be virtualized per sessions between remote terminal server and client devices. Because of this, the device node for a driver in one session can get overwritten with a driver in another session, in particular when the same mirror driver is loaded in both of the sessions. For example, a mirror driver might have been loaded at 8 bits per pixel (bpp) in one session, and might be loaded at 16 bpp in another session. To overcome this shortcoming, device node information is “sessionized” meaning that each session keeps the device node info in its internal memory without writing to the Windows® system registry. In this way, the device node info for one session does not overwrite or create problems in another session.

### Exemplary System

FIG. 1 shows an exemplary remote server access system 100 loaded with a mirror driver in a client-server computing environment. To this end, the system 100 includes a server computing device or server 102 communicating through a network 104 with one or more client computing devices or client computing devices 106-1, 106-2, . . . 106-N. The system 100 may be a Terminal Service™ system as provided or defined by the Microsoft® Corporation, where the multiple client computing devices 106 rely on applications that are executed on the server 102. Such applications may provide functionality, and particularly include one or more graphics applications.

The server computing device 102 may be implemented with an operating system (e.g. Windows®) operating system of Microsoft® Corporation. The server 102 and the client computing devices 106 may implement a communication protocol such as remote desktop protocol (RDP), in order to pass data or information (i.e., communicate) with one another. The use of such communication protocols, and particularly RDP, may be implemented in the context of a remote client access system such as a Terminal Services™ system.

The server 102 may be implemented as any of a variety of conventional computing devices, including, for example, a desktop PC, a notebook or portable computer, a workstation, a mainframe computer, a mobile computing device, an entertainment device, a game console, an Internet appliance, etc. that may be configured to be loaded withy mirror drivers. The server 102 may also include one or more of the aforementioned conventional computing devices configured as a server in a server-client computing environment.

The client computing devices or client computing devices 106 may be a general-purpose PC (personal computer), a laptop PC, a tablet PC, or the like, and may implement an operating system such as a Windows® brand operating system from the Microsoft® Corporation. The client computing devices 106 may be a standalone computer that a primarily interface to server 102 to access files or other information (e.g., application programs resident at the server computing device 102) that are not locally stored at client computing device 106.

The network 104 may be a wireless or a wired network, or a combination thereof. The network 104 may also be a collection of individual networks, interconnected with each other and functioning as a single large network (e.g., the Internet or an intranet). Examples of such individual networks include, but are not limited to, Local Area Networks (LANs), Wide Area Networks (WANs), and Metropolitan Area Networks (MANs). Further, the individual networks may be wireless or wired networks, or a combination thereof. Moreover, the network 104 connecting the server 102 and client computing devices 106 may implement a transport protocol such as transmission control protocol over Internet protocol (TCP/IP).

The server 102 may host applications that may rely on mirror drivers which are accessed or executed by the client computing devices 106. Such applications or scenarios may include, for example, a collaborative screen sharing application, net meeting, desktop magnifier applications, and other similar applications. Execution of such applications results in one or more remote sessions between the server 102 and the client computing devices 106.

The server 102 may be loaded with one or more of display drivers and one or more mirror drivers. The server 102 may need to access the mirror drivers and display drivers. The identification process may be implemented by high level graphics module 108 by initially identifying the display drivers, collecting details of the display drivers and adding the details to a graphics device list. The high level graphics module 108 may include modules associated with graphics engine (GRE), graphics device interface (GDI), etc. The details of the display drivers may be added to a remote graphics device list of a program such as “Win32k.sys.” For purposes of illustration, Win32k.sys is Windows® subsystem that includes two parts, namely window manager (called NTUSER) and graphics device interface (GDI). The mirror drivers are accessed by high level graphics module 108 and details obtained are added into the graphics device list. The procedure of obtaining the details from the mirror drivers are described in detail below.

Once the mirror drivers and display drivers are registered in to the graphics device list, the high level graphics module 108 loads the mirror drivers in the server 102. The high level graphics module 108 typically follows a code path in loading the mirror drivers which is described in detail below. Further, the display drivers may be unloaded by the program Win32k.sys during a termination of sessions.

Upon loading and unloading the mirror drivers and the display drivers, respectively, a video initialization for sessions may be triggered by a graphics window manager 110. The graphics window manager 110 sends a video initiating routine to the high level graphics module 108 to trigger a video initialization sequence in the high level graphics module 108. Thus, data from high level graphics module 108 is received by the graphics window manager 110 and stored in a form of global structure.

The server 102 queries a global structure using a utility routine to identify the display drivers and mirror drivers. A global structure may be formed once a graphics window manager 110 stores a video transmitted upon video initialization. In this case, the graphics window manager 108 triggers a video initialization for a session upon receipt of a request for a connection from the server 102 to a program Win32k.sys.

The program Win32k.sys identifies various display drivers, and loads actual instances of display drivers in separate session spaces. The actual instances are loaded once the program Win32k.sys initiates a low level graphics infrastructure 112 to determine if we need to open the mirror driver.

Thus, in the remote server access system 100, loading of mirror driver enables client computing devices 106-1, 106-2, and 106-N to open a plurality of sessions which may be a reflection of a remote session (i.e. session of the server 102). For example, client computing devices 106-1, 106-2, and 106-N opens plurality of sessions of a session of the server 102 in the remote server access system 100. In such a case, the mirror driver loaded in the server 102 facilitates the client computing device 106-1 to modify graphics features of its display devoid of any changes being made in client computing devices 106-2, and 106-N simultaneously. It may be appreciated that the above description may be applied to the other one or more client computing devices 106-2 . . . 106-N to modify graphics features of their display avoiding any changes to be made in other client computing devices 106.

### Exemplary Server Computing Device

FIG. 2 shows an implementation of the server computing device 102 capable of being loaded with a mirror driver. The server 102 includes one or more processor(s) 200 coupled to a memory 202. Such processor(s) 200 could be for example, microprocessors, microcomputers, microcontrollers, digital signal processors, central processing units, state machines, logic circuitries, and/or any devices that manipulate data based on operational instructions. The processor(s) 200 are configured to fetch and execute computer-program instructions stored in the memory 202. Memory 202 includes computer-readable media in the form of volatile memory, such as Random Access Memory (RAM) and/or non-volatile memory, such as Read Only Memory (ROM) or flash RAM or a combination thereof.

The memory 202 may include operating system 204 that provides a platform for execution of one or more applications on the server 102. The memory 202 may also include one or more server applications 206 or scenarios that include, for example, collaboration screen sharing, net meeting, etc. The server application 206 may be executed upon receiving a request from one or more client computing devices 106. In typical server-client architecture, the server 102 functions as an application server where the client computing devices 106 rely on applications, which execute on the server 102 for all or certain application programs that provide functionality, and particularly access and control of one or more server applications 206. Execution of the server applications 206 instantiates one or more sessions between the server 102 and the client computing devices 106. The server 102 is loaded with one or more display driver(s) 208 and mirror driver(s) 210.

In an exemplary implementation, the server 102 is configured to be loaded with the display driver(s) 208 and the mirror driver(s) 210. Once, the display driver(s) 208 and the mirror driver(s) 210 are coupled to the server 102, the high level graphics module 108 accesses the display driver(s) 208 and the mirror driver(s) 210 and updates the graphics device list with the details of the display driver(s) 208 and the mirror driver(s) 210 using an application program interface or API. Such details may be obtained from a registry, where the registry may be an internal database for an operating system (i.e., a Windows® based operating system). Details about installed display drivers in the system can be obtained by reading the registry database and added to a remote graphics device list maintained by the program Win32k.sys, for example an internal data structure which contains a list of display drivers visible to the a remote terminal server session. The remote graphics device list may include information of the display driver(s) 208 visible to the server 102.

Further, once each mirror driver(s) 210 is loaded in the server 102, the program Win32k.sys can opens a handle to a video port or input/output interface(s) 212. The handle may be opened by sending a specific API to the video port. The collected information may be stored internally in win32k.sys specific data structures (e.g., a data structure used to represent a physical display inside the system).

In the present scenario a change of an exclusive open to non-exclusive open for the mirror driver(s) 210 is made by the program Win32k.sys. Further, routines in a program ‘videoprt.sys’ (i.e. a program for controlling an operation of the video port) and employed by the program Win32k.sys to determine if the current open is for the mirror driver(s) 210.

In the case of remote sessions, the program win32k.sys passes the handle down to an actual display driver 208, for example, Remote Desktop Protocol Display Driver (RDPDD) or Remote Desktop Protocol Encoder Display Driver (RDPENCDD). The handle may be used to make an “IOCTL” call to the video port requesting for “IOCTL_VIDEO_QUERY_NUM_AVAIL_MODES”. In other words, this call is frrom Win32k.sys to the video port and asks for the capabilities of a device as to how many modes does the device support.

In one exemplary implementation, an API may facilitate console sessions associated with client computing devices 106 to enumerate details of the display driver(s) 208 and the mirror driver(s) 210, where such API may allow a “walk through” of the registry and populate internal data structures with information on what display devices are present, which of them are physical devices, which of them are mirror drivers, etc. In another implementation, the details of the mirror driver(s) 210 included in the updated graphics device list includes mirror driver(s) 210 possessing a server 102 compatible (i.e. ‘TSCompatible’ or ‘Terminal Server Compatible’) flag to the updated graphics device list.

The mirror driver(s) 210 identified is loaded with a session space of server 102 (i.e. remote server). This may be accomplished by the high level graphics module 108 querying a registry 214 whether the display driver(s) 208 and the mirror driver(s) 210 are available for load. It may be noted that the registry 214 may be accessible to the console sessions (i.e. sessions of client computing devices 106) and the remote server sessions. The registry 214 includes for example, the graphics device list and the updated graphics device list. The query may be made by the level graphics module 108 to identify whether a display device associated with display driver(s) 208 is available for load (i.e. whether the display device is enabled).

The high level graphics module 108 may query the display driver(s) 208 to identify modes (i.e. may be part of server data 216) that may be supported by the display driver(s) 208. The modes may be obtained by the high level graphics module 108 employing APIs, for example an internal API that talks to a display driver and gets the list of modes the display driver supports.

The path associated with the process of obtaining the modes includes three steps for example: 1) probing and capturing the display driver(s) 208 to obtain the modes; 2) preparing a driver mode list including the modes supported by the display driver(s) 208 upon receipt of the details of the modes from the display driver(s) 208, and 3) collecting the modes from the driver mode list.

For exemplary illustration, ‘Devmode’ is described as a structure that includes details of the display devices and may be stored within the memory of associated with the high level graphics module 108. Thus, any changes made in the modes are not reflected in any of the console sessions. Then, the high level graphics module 108 enables the mirror driver(s) 210 using an API(s). Further, the high level graphics module 108 loads the display driver(s) 208 and the mirror driver(s) 210 employing API(s).

In an implementation, a session that is terminated by the display driver(s) 210 may be unloaded by the program Win32k.sys. The path adopted by the program Win32k.sys may be a process that unloads the Win32k subsystem during session termination. Furthermore, some cleanup happens as part of the unloading. Once, the display driver(s) 208 and the mirror driver(s) 210 are loaded, the graphics window manager 110 may send a command such as “InitVideo” (initialize video) routine to the high level graphics module 108 to initiate a video initialization sequence in the high level graphics module 108. Thus, data from high level graphics module 108 is received by the graphics window manager 110 and may be stored in a form of a global structure in memory 202 (e.g., an internal data structure used by window manage to keep track of a display device). The program Win32k.sys may send DrvEscape (driver escape) commands to a meta device, where the meta device is examined to query each handle to the device to identify a ideal handle to the device associated with the remote display driver(s) 208.

In another implementation, a routine may be employed by the program Win32k.sys to examine the physical devices or “PDEV” (where PDEV is an internal data structure representing a physical device) in a meta-device to identify an ideal “PDEV” representing the remote display driver(s) 208. In an implementation, a routine may be requested by another routine from the graphics window manager 110. “MDEV” may be defined as a meta device, where an MDEV may contain more than one physical devices (i.e., PDEVs). It may also follow that an MDEV can have more than one HDEV, one corresponding to each PDEV. For example, in a multi-monitor system with two video cards, the MDEV may contain two PDEVs (and two HDEVs), one corresponding to each video card/driver combination. A handle associated with a display device associated with a single display driver 208, may be returned to the program Win32k.sys. Furthermore, the server computing device 102 includes a network interface 212 to enable communication with the client computing devices 106 through the network 104.

Exemplary methods

Exemplary methods for loading mirror drivers to remote server computing devices are described with reference to FIGS. 1 to 2. These exemplary methods may be described in the general context of computer executable instructions. Program modules generally include routines, programs, objects, components, data structures, etc., that perform particular tasks or implement particular abstract data types. While the systems and methods are described in the foregoing contexts, acts and operations described hereinafter may be implemented in hardware or other forms of computing platforms.

FIG. 3 illustrates an exemplary method 300 for loading mirror drivers to remote server computing devices. The order in which the method is described is not intended to be construed as a limitation, and any number of the described method blocks can be combined in any order to implement the method, or an alternate method. Additionally, individual blocks may be deleted from the method without departing from the spirit and scope of the subject matter described herein. Furthermore, the method can be implemented in any suitable hardware, software, firmware, or combination thereof.

At block 302, a mirror driver 210 is set up in the server 102. In certain embodiments, the mirror driver 210 may be detected by the high level graphics module 108.

At block 304, the mirror driver 210 is accessed by the server 102 to obtain information of the mirror driver 210. The high level graphics module 108 accesses the mirror driver 210 and gathers required information of the mirror driver 210. The gathered information is added into a graphics device list stored in the registry 214. The information may include parameters associated with the mirror driver 210. The parameters may include modes, configurations, etc. In one implementation, the high level graphics module 108 obtains the parameters and prepares a list of parameters (i.e. driver mode list) prior to loading the mirror driver 210.

In one embodiment, the high level graphics module 108 accesses the information of the mirror driver 210 and further configured to allow the console sessions to enumerate mirror driver 210.

At block 306, loading the mirror driver 208 in the server 102. In particular, the information associated with the mirror driver 208 is collected and analyzed to identify a status of the mirror driver 208. The status of the mirror driver 208 denotes whether the mirror driver 208 is enabled. Then, the mirror driver 208 is loaded into the server 102.

### Exemplary Computer

FIG. 4 shows an exemplary computing device or computer 400 suitable as an environment for practicing aspects of the subject matter. In particular, computer 400 may be a detailed implementation of computers and/or computing devices described above. Computer 400 is suitable as an environment for practicing aspects of the subject matter. The components of computer 400 may include, but are not limited to processing unit 405, system memory 410, and a system bus 421 that couples various system components including the system memory 410 to the processing unit 405. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as the Mezzanine bus.

Exemplary computer 400 typically includes a variety of computer-readable media. Computer-readable media can be any available media that can be accessed by computer 400 and includes both volatile and nonvolatile media, removable and non-removable media. By way of example, and not limitation, computing device-readable media may comprise computer storage media and communication media. Computer storage media include volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 400. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection and wireless media such as acoustic, RE, infrared and other wireless media. Combinations of any of the above should also be included within the scope of computing device readable media.

The system memory 410 includes computing device storage media in the form of volatile and/or nonvolatile memory such as read only memory (ROM) 431 and random access memory (RAM) 432. A basic input/output system 433 (BIOS), containing the basic routines that help to transfer information between elements within computer 400, such as during start-up, is typically stored in ROM 431. RAM 432 typically contains data and/or program modules that are immediately accessible to and/or presently being operated on by processing unit 405. By way of example, and not limitation, FIG. 4 illustrates operating system 434, application programs 435, other program modules 436, and program data 437.

The computer 400 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computing device storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface such as interface 450.

The drives and their associated computing device storage media discussed above and illustrated in FIG. 4 provide storage of computer-readable instructions, data structures, program modules, and other data for computer 400. In FIG. 4, for example, hard disk drive 441 is illustrated as storing operating system 444, application programs 445, other program modules 446, and program data 447. Note that these components can either be the same as or different from operating system 434, application programs 435, other program modules 436, and program data 437. Operating system 444, application programs 445, other program modules 446, and program data 447 are given different numbers here to illustrate that, at a minimum, they are different copies. A user may enter commands and information into the exemplary computer 400 through input devices such as a keyboard 448 and pointing device 461, commonly referred to as a mouse, trackball, or touch pad. Other input devices (not shown) may include a microphone, joystick, game pad, satellite dish, scanner, or the like. These and other input devices are often connected to the processing unit 420 through a user input interface 460 that is coupled to the system bus, but may be connected by other interface and bus structures, such as a parallel port, game port, or in particular a USB port.

A monitor 462 or other type of display device is also connected to the system bus 421 via an interface, such as a video interface 490. In addition to the monitor 462, computing devices may also include other peripheral output devices such as speakers 497 and printer 496, which may be connected through an output peripheral interface 495.

The exemplary computer 400 may operate in a networked environment using logical connections to one or more remote computing devices, such as a remote computing device 480. The remote computing device 480 may be a personal computing device, a server, a router, a network PC, a peer device or other common network node, and typically includes many or all of the elements described above relative to computer 400. The logical connections depicted in FIG. 4 include a local area network (LAN) 471 and a wide area network (WAN) 473. Such networking environments are commonplace in offices, enterprise-wide computing device networks, intranets, and the Internet.

When used in a LAN networking environment, the exemplary computer 400 is connected to the LAN 471 through a network interface or adapter 470. When used in a WAN networking environment, the exemplary computer 400 typically includes a modem 472 or other means for establishing communications over the WAN 473, such as the Internet. The modem 472, which may be internal or external, may be connected to the system bus 421 via the user input interface 460, or other appropriate mechanism. In a networked environment, program modules depicted relative to the exemplary computer 400, or portions thereof, may be stored in a remote memory storage device. By way of example, and not limitation, FIG. 4 illustrates remote application programs 485. It will be appreciated that the network connections shown are exemplary and other means of establishing a communications link between the computing devices may be used.

### Conclusion

The above-described systems and methods describe loading and using a mirror display driver in a remote terminal server session. Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A server comprising:
a memory;
one or more processors operatively coupled to the memory;
one or more mirror drivers in the memory; and
a graphics module configured to access and load the mirror drivers in a remote server sessions, whereby one or more scenarios are possible in remoting sessions run at a client device.

2. The server of claim 1, wherein the one or more mirror drivers and one or more display drivers, are registered in a graphics device list.

3. The server of claim 2, wherein the graphics device list includes information of display drivers that are visible to the server.

4. The server of claim 1, wherein details of the mirror drivers are added to a graphics device list.

5. The server of claim 4, wherein the details are obtained from a registry of the server.

6. The server of claim 1, wherein graphics module identifies if the client device is enabled for loading.

7. The server of claim 1, wherein the sessions are stored as part of client device node information.

8. The server of claim 1 further comprising a program that triggers a video initialization to open the sessions.

9. A system comprising:
a server; and
one or more client devices in remote session with the server, wherein one or more mirror drivers in the server facilitates the client devices to modify graphics features of a display of each of the client devices.

10. The system of claim 9, wherein the server hosts applications that rely on the one or more mirror drivers and are accessed by the client devices.

11. The system of claim 10, wherein the applications include one or more of the following: collaborative screen sharing, net meeting, and desktop mangnifier.

12. The system of claim 9, wherein the loading of the mirror driver in a remote session enhances functionality and makes other scenarios.

13. The system of claim 9, wherein modifying graphics features of a display of a client device is independent of other client devices.

14. A method comprising:
setting a mirror driver in a server;
accessing the mirror driver to obtain information regarding the mirror driver; and
loading the mirror deriver into the server.

15. The method of claim 14, wherein the setting is performed by detecting the presence of the mirror driver.

16. The method of claim 14, wherein the accessing includes adding the information to a graphics device list.

17. The method of claim 14, wherein the information includes parameters associated with the mirror driver, the parameters include modes and configurations.

18. The method of claim 14, wherein the information is configured to allow remote sessions to enumerate the mirror driver.

19. The method of claim 14, wherein the loading includes collecting the information to determine status of the mirror driver.

20. The method of claim 19, wherein the status denotes whether the mirror driver is loaded.
